(19) United States
(12) Patent Application Publication
(10) Pub. No.: US 2010/0123964 A1
(43) Pub. Date: May 20, 2010

(54) STORAGE DEVICE AND CONTROL DEVICE

(75) Inventor: Tatsuya Haga, Higashine (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/570,981

(22) Filed: Sep. 30, 2009

(30) Foreign Application Priority Data
Nov. 17, 2008 (JP) 2008-293790

(51) Int. Cl. G11B 27/36

(52) U.S. Cl. 360/31; G9B/27.052

(57) ABSTRACT

According to one embodiment, a vibration correspondence information storage module stores, each time process such as reading and writing is performed, a head performing the process, a vibration amount of the head upon performing the process, and a process retry count in association with one another as vibration correspondence information. A process completion prediction time calculator calculates, upon determining a next execution command from among unexecuted read and write commands, process completion prediction time based on arrival time taken for a scheduled execution head to arrive at a scheduled process position from the current position, and a process retry count associated with the scheduled execution head and a current vibration amount thereof in the vibration correspondence information. A next execution command determining module determines the next execution command based on the process completion prediction time.

### CROSS-REFERENCE TO RELATED APPLICATIONS

This application is based upon and claims the benefit of priority from Japanese Patent Application No. 2008-293790, filed Nov. 17, 2008, the entire contents of which are incorporated herein by reference.

### BACKGROUND

1. Field

One embodiment of the invention relates to a storage device and a control device.

2. Description of the Related Art

In storage devices provided with a built-in storage medium, to execute a read/write command received from a host computer at a high speed, control has been performed using a data buffer that temporarily stores data exchanged with the host computer.

For example, when a write command is issued from the host computer, a storage device once registers write data transmitted from the host computer in a command waiting matrix in the data buffer. Then, the storage device determines write data that can be written fastest among the write data registered in the command waiting matrix based on a physical position on a storage medium, and reads the determined write dada from the data buffer and writes the write data to the storage medium.

Specifically, based on the current position of a head to read/write data with respect to the storage medium and a write position of each write data on the storage medium, the storage device calculates an arrival time taken for the head to arrive at the write position from the current position for each piece of write data. More specifically, the storage device calculates the arrival time from a time taken for the head to move to a track where the write position exists (hereinafter, “seek time”) and a rotation waiting time until the write position on the storage medium rotates to the position of the head.

The storage device performs writing of write data with the shortest the arrival time. After the writing, the storage device calculates again the arrival time from the current position of the head with respect to each piece of write data remaining in the command waiting matrix, and determines the next write data.

When a read command is issued from the host computer, similar to writing operation, the storage device sequentially determines a read command of which an arrival time is the shortest based on the current position of the head and a read position of each piece of read data on the storage medium.

In this manner, the storage device determines a command to be executed next (hereinafter, “next execution command”) for every process with respect to each piece of data stored in the data buffer to perform a process according to a command from the host computer in the shortest time.

In this case, if off-track occurs in which the position of the head to perform reading/writing operation deviates from a targeted track due to an external environment factor, such as vibration, the storage device may retry to perform the reading/writing operation.

For example, Japanese Patent Application Publication (KOKAI) No. 2002-304823 discloses a conventional technology for determining a next execution command considering the retry. With the conventional technology, a retry count is stored for every seek direction of the head, and a command of seek direction where a retry count is small is preferentially executed when reading/writing operation is performed.

However, in the conventional technology, the process of a command when vibration is generated cannot be performed in the shortest time. That is, in an execution of each command when vibration is generated, since the count of the retry is not considered, an accurate process time cannot be predicted, and a process time of the preferentially selected command is not always the shortest.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary view of an outline of a storage device according to a first embodiment of the invention;

FIG. 2 is an exemplary block diagram of the storage device in the first embodiment;

FIG. 3 is an exemplary diagram for explaining vibration correspondence information in the first embodiment;

FIG. 4 is an exemplary diagram for explaining differential information in the first embodiment;

FIG. 5 is an exemplary diagram for explaining an arrival time calculating process performed by a process completion prediction time calculator in the first embodiment;

FIG. 6 is an exemplary diagram for explaining a process completion prediction time calculating process performed by the process completion prediction time calculator in the first embodiment;

FIGS. 7A to 7C are exemplary diagrams for explaining a process completion prediction time calculation of a process completion prediction time calculator in the first embodiment;

FIG. 8 is an exemplary flowchart of an acquiring process of vibration correspondence information and differential information performed by the storage device in the first embodiment;

FIG. 9 is an exemplary flowchart of a next execution command determining process performed by the storage device in the first embodiment;

FIG. 10 is an exemplary view of an outline of a storage device according to a second embodiment of the invention;

FIG. 11 is an exemplary flowchart of an acquiring process of vibration correspondence information and differential information performed by the storage device in the second embodiment;

FIG. 12 is an exemplary flowchart of a next execution command determining process performed by the storage device in the second embodiment;

FIG. 13 is an exemplary view of an outline of a storage device according to a third embodiment of the invention; and

FIG. 14 is an exemplary flowchart of a next execution command determining process performed by the storage device in the third embodiment.

### DETAILED DESCRIPTION

Various embodiments according to the invention will be described hereinafter with reference to the accompanying drawings. In general, according to one embodiment of the invention, a storage device comprises a vibration correspondence information storage module, a process completion prediction time calculator, and a next execution command determining module. The vibration correspondence information storage module is configured to store, each time process is performed with respect to a storage medium, a head performing the process, a vibration amount of the head upon performing the process, and a process retry count indicating the number of retries performed before the process is completed in association with one another as vibration correspondence information. The process includes reading and writing with respect to the storage medium. The process completion prediction time calculator is configured to calculate, upon determining a next execution command to be executed next from among a plurality of unexecuted commands yet to be executed, for each of the unexecuted commands, process completion prediction time indicating the time expected to be taken to complete process corresponding to the unexecuted command based on arrival time taken for a scheduled execution head that is to perform the process in response to the unexecuted command to arrive at a scheduled process position where the process is to be performed from a current position on the storage medium, and a process retry count associated with the scheduled execution head and a current vibration amount of the scheduled execution head in the vibration correspondence information stored in the vibration correspondence information storage module. The unexecuted commands include read commands and write commands with respect to the storage medium. The next execution command determining module is configured to determine an unexecuted command with the shortest process completion prediction time as the next execution command based on the process completion prediction time calculated for each of the unexecuted commands by the process completion prediction time calculator.

According to another embodiment of the invention, a control device is configured to control a storage device that performs reading and writing by a head with respect to a storage medium. The control device comprises a vibration correspondence information storage module, a process completion prediction time calculator, and a next execution command determining module. The vibration correspondence information storage module is configured to store, each time process is performed with respect to a storage medium, a head performing the process, a vibration amount of the head upon performing the process, and a process retry count indicating the number of retries performed before the process is completed in association with one another as vibration correspondence information. The process includes reading and writing with respect to the storage medium. The process completion prediction time calculator is configured to calculate, upon determining a next execution command to be executed next from among a plurality of unexecuted commands yet to be executed, for each of the unexecuted commands, process completion prediction time indicating the time expected to be taken to complete process corresponding to the unexecuted command based on arrival time taken for a scheduled execution head that is to perform the process in response to the unexecuted command to arrive at a scheduled process position where the process is to be performed from a current position on the storage medium, and a process retry count associated with the scheduled execution head and a current vibration amount of the scheduled execution head in the vibration correspondence information stored in the vibration correspondence information storage module. The unexecuted commands include read commands and write commands with respect to the storage medium. The next execution command determining module is configured to determine an unexecuted command with the shortest process completion prediction time as the next execution command based on the process completion prediction time calculated for each of the unexecuted commands by the process completion prediction time calculator.

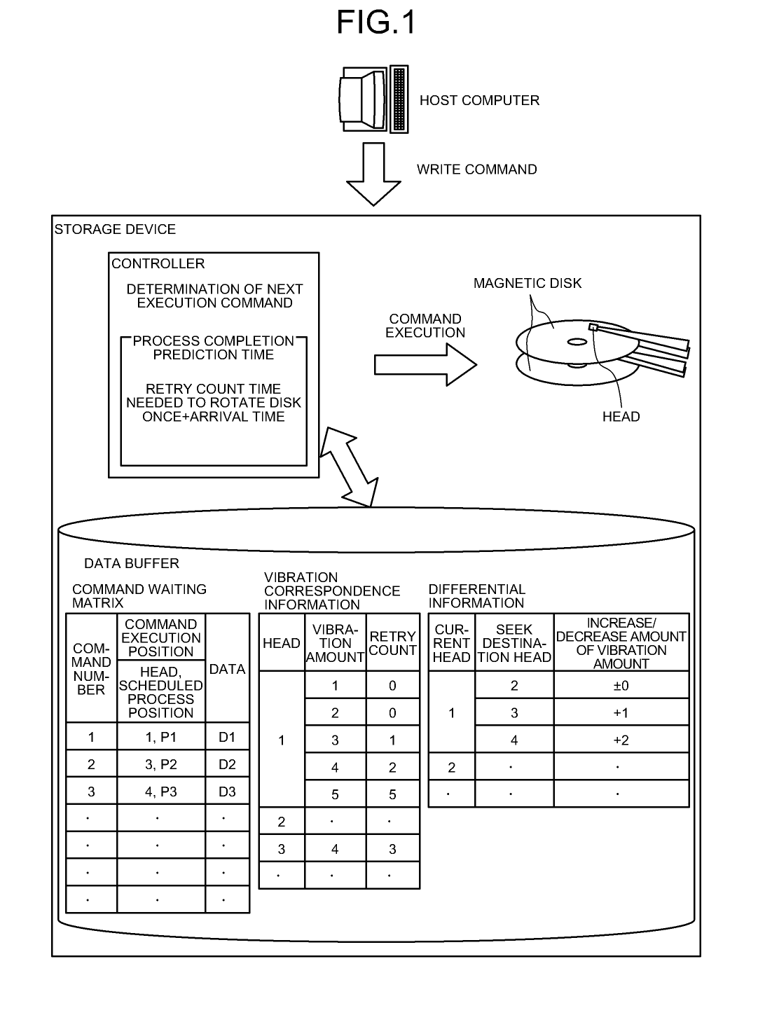

First, the outline of the storage device according to a first embodiment of the invention will be described with reference to FIG. 1. FIG. 1 illustrates the outline of the storage device according to the first embodiment.

The storage device of the first embodiment temporarily stores write data corresponding to a write command received from a host computer in a data buffer, sequentially reads the stored write data by a controller, and performs writing using a head with respect to a disk. In the first embodiment, as illustrated in FIG. 1, the case is described where two magnetic disks are incorporated in the storage device and one head is arranged on each of front and rear surfaces of each disk.

Specifically, when the storage device receives a plurality of write commands from the host computer, the storage device registers the received write commands in a command waiting matrix of a data buffer. For example, as illustrated in FIG. 1, the storage device of the first embodiment associates a “command execution position: 1, P1” of a “command number: 1” with “data: D1” as write data corresponding to the “command number: 1”, as a command waiting matrix of the “command number: 1”, and registers an association result. At the command execution position, “1” indicates a scheduled execution head which is scheduled to perform writing corresponding to the “command number: 1”, and “P1” indicates a scheduled process position where an execution of writing to the disk of the “command number: 1” is scheduled. A controller of the storage device of the first embodiment determines a command to be executed next (hereinafter, “next execution command”) among the write commands registered in the command waiting matrix.

The salient feature of the first embodiment is that a command of which a process time when a vibration is generated is the shortest can be accurately determined. This feature will be described in brief. The storage device of the first embodiment previously stores vibration correspondence information and differential information to be described in detail below to determine a next execution command from the command waiting matrix. That is, the storage device of the first embodiment stores vibration correspondence information where an execution head of a write command process, the vibration amount in the execution head, and a retry count until the write command process is completed are associated with each other, each time the write command process is performed by the head with respect to the disk. For example, when the process execution head is “1”, the vibration amount when the head “1” performs the process is “3”, and the retry count is “1”, the storage device of the first embodiment stores vibration correspondence information of “head: 1, vibration amount: 3, and retry count: 1” in the data buffer, as illustrated in FIG. 1. The storage device of the first embodiment determines the vibration amount from the off-track amount of when the write command is executed.

When the head used to execute the write command process is changed, the storage device of the first embodiment further stores the increase/decrease amount of the vibration amount between the heads before and after the change as differential information. For example, when the head before the change is “1”, the head after the change is “3”, and the increase/decrease amount of the vibration amount between the heads before and after the change is “+1”, as illustrated in FIG. 1, the storage device of the first embodiment stores differential information of “current head: 1, seek destination head: 3, and increase/decrease amount: +1” in the data buffer. The current head indicates a head before the change, and the seek destination head indicates a head after the change.

The controller of the storage device of the first embodiment determines a next execution command among write commands where a process is not performed with respect to the disk. That is, the controller of the storage device of the first embodiment determines a next execution command among unexecuted commands that are received from the host computer and registered in the command waiting matrix. Specifically, first, the controller of the storage device of the first embodiment calculates an arrival time needed until a scheduled execution head for each of the unexecuted commands registered in the command waiting matrix arrives from a current position on the disk to a scheduled process position. The arrival time is calculated by adding a seek time needed until a head is moved to a track where a scheduled process position exists and a rotation waiting time needed until a scheduled process position on the disk rotates to a position of the scheduled execution head.

The controller of the storage device of the first embodiment calculates a predicted process completion prediction time indicating the time expected to be taken to complete a process corresponding to the unexecuted command from the calculated arrival time and a retry count corresponding to the scheduled execution head and the current vibration amount of the scheduled execution head in the vibration correspondence information.

When a head that performs immediately previous process (hereinafter, “immediately previous execution head”) in response to a write command (hereinafter, “immediately previous execution command”) is the same as the scheduled execution head of the unexecuted command, the controller of the storage device of the first embodiment calculates the process completion prediction time based only on the vibration correspondence information.

For example, when the immediately previous execution head is “1” and the vibration amount in the head “1” is “3”, the controller of the storage device of the first embodiment calculates a process completion prediction time of a “command number: 2” illustrated in FIG. 1 as follows. First, the controller of the storage device of the first embodiment determines the current vibration amount in the scheduled execution head “1” as “3”, because the scheduled execution head of the “command number: 1” is “1” and is the same as the immediately previous execution head “1”, as illustrated in FIG. 1.

In addition, the controller of the storage device of the first embodiment acquires the retry count “1” corresponding to the vibration amount “3” in the head “1” from the vibration correspondence information, and calculates a process completion prediction time from the acquired retry count “1”, a time needed until the disk rotates once, and an arrival time. When an arrival time needed until the scheduled execution head of the “command number: 1” illustrated in FIG. 1 arrives to the scheduled process position “P1” is “10 ms” and the time needed until the disk rotates once is “1.1 ms”, the controller of the storage device of the first embodiment calculates the process completion prediction time as “1×11.1+10=21.1 ms”.

Meanwhile, the controller of the storage device of the first embodiment calculates a process completion prediction time using vibration correspondence information and differential information, when the scheduled execution head is changed from the immediately previous execution head. That is, the controller derives the current vibration amount in the scheduled execution head, from the vibration amount of the immediately previous execution head and the increase/decrease amount of the vibration amount between the heads before and after the change acquired from the differential information. The controller acquires the retry count corresponding to the scheduled execution head and the derived vibration amount from the vibration correspondence information, and calculates the process completion prediction time from the acquired retry count and the arrival time.

For example, when the immediately previous execution head is “1” and the vibration amount in the head “1” is “3”, the controller of the storage device of the first embodiment calculates the process completion prediction time of the “command number: 2” illustrated in FIG. 1 as follows. First, after the scheduled execution head “3” of the “command number: 2” is changed from the immediately previous execution head “1”, the controller of the storage device of the first embodiment derives the current vibration amount in the scheduled execution head based on the vibration amount of the immediately previous execution head and the differential information illustrated in FIG. 1. That is, the controller of the storage device of the first embodiment determines the immediately previous execution head 1 as the current head, determines the scheduled execution head “3” as a seek destination head “3”, and acquires the increase/decrease amount “+1” of the corresponding vibration amount from the differential information. In addition, the controller of the storage device of the first embodiment adds the acquired increase/decrease amount “+1” to the vibration amount “3” in the immediately previous execution head, and derives the vibration amount “4” obtained by the addition as the current vibration amount in the scheduled execution head “3” of the “command number “2”.

The controller of the storage device of the first embodiment acquires the retry count “3” corresponding to the vibration amount “4” in the head “3” from the vibration correspondence information, and calculates the process completion prediction time from the acquired retry count “3”, the time needed until the disk rotates once, and the arrival time. When the arrival time needed until the scheduled execution head of the “command number: 2” illustrated in FIG. 1 arrives to the scheduled process position “P2” is “5 ms” and the time needed until the disk rotates once is “11.1 ms”, the controller of the storage device of the first embodiment calculates the process completion prediction time as “3×11.1+5=38.1 ms”.

In addition, the controller of the storage device of the first embodiment calculates the process completion prediction time with respect to all of the unexecuted commands, and determines a write command, which needs the shortest process completion prediction time among the calculated process completion prediction times, as a next execution command.

After the next execution command is determined, the storage device of the first embodiment calculates the process completion prediction time again with respect to the unexecuted commands remaining in the command waiting matrix, and determines the unexecuted command where the process time is the shortest as the next execution command.

The storage device of the first embodiment can calculate a process completion prediction time of each command in consideration of the retry count when the vibration is generated, to determine the next execution command, and accurately determine a command where the a process time of when the vibration is generated is the shortest, as described above.

The storage device of the first embodiment acquires the vibration amounts in the heads of all of the write commands executed when the vibration is generated and the retry counts, and updates the vibration correspondence information and the differential information in the data buffer using the acquired heads, vibration amounts, and retry counts.

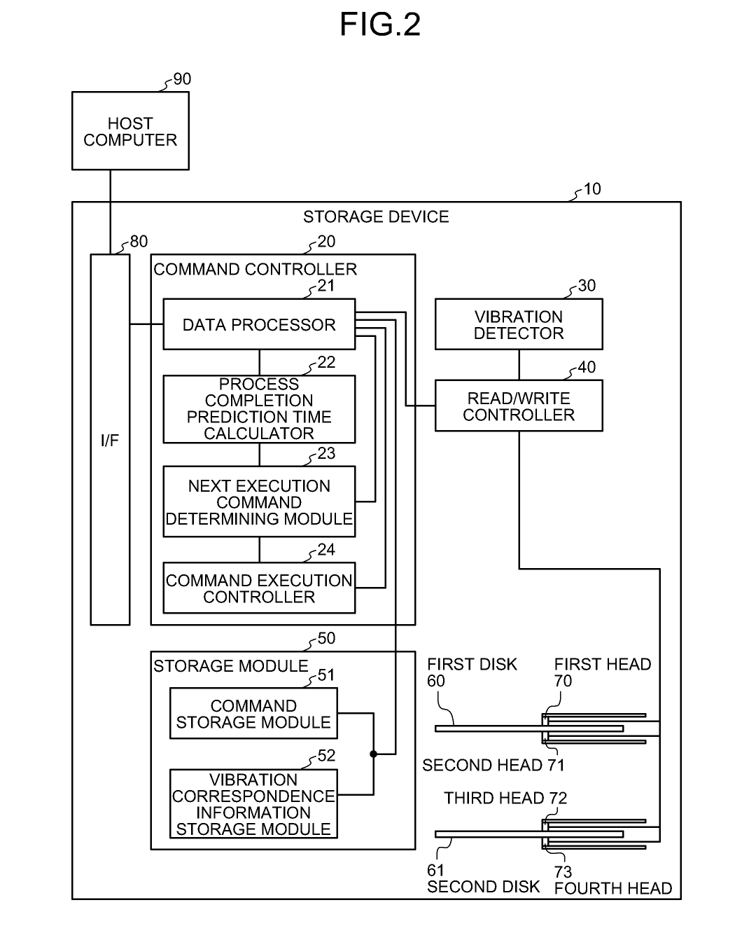

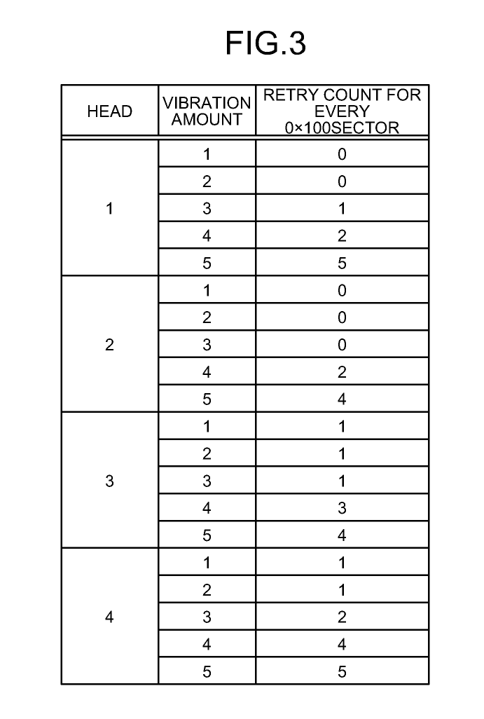

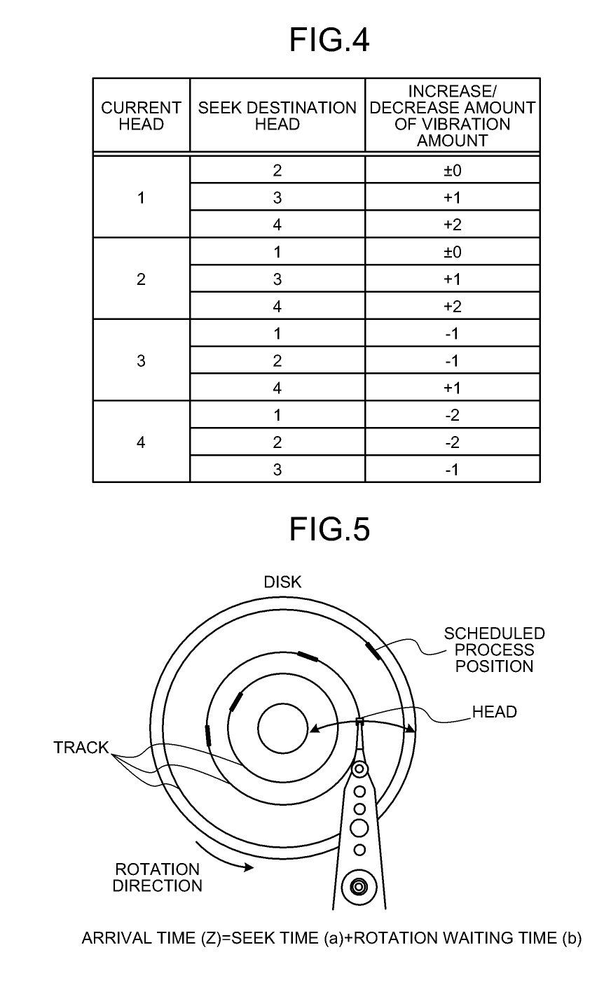

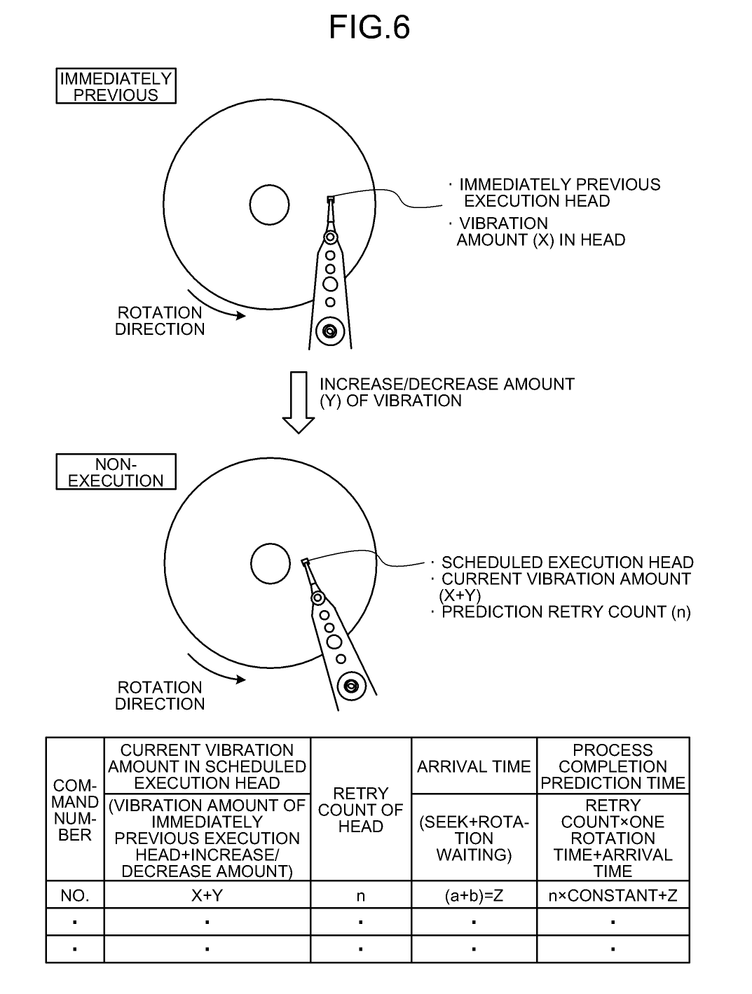

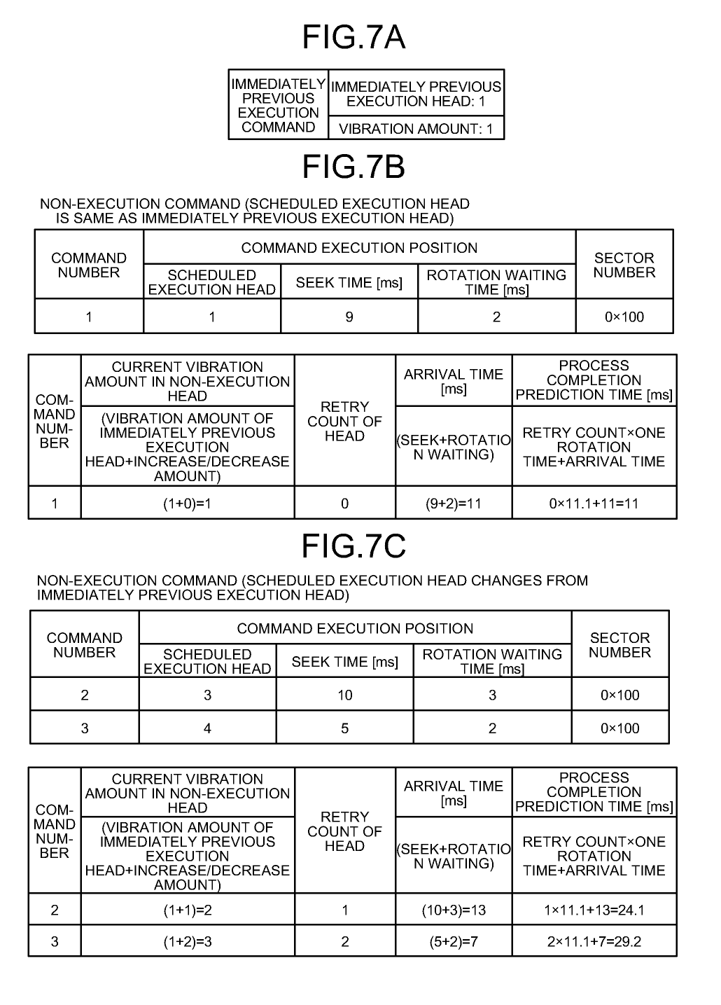

Next, the configuration of the storage device of the first embodiment will be described with reference to FIGS. 2 to 7. FIG. 2 is a block diagram of the storage device of the first embodiment. FIG. 3 illustrates vibration correspondence information in the first embodiment. FIG. 4 illustrates differential information in the first embodiment. FIG. 5 illustrates an arrival time calculating process in a process completion prediction time calculator. FIG. 6 illustrates a process completion prediction time calculating process of the process completion prediction time calculator of the first embodiment. FIG. 7 illustrates an example of a process completion prediction time calculation of the process completion prediction time calculator of the first embodiment.

As illustrated in FIG. 2, a storage device 10 of the first embodiment comprises an I/F 80, a storage module 50, a command controller 20, a first head 70, a second head 71, a third head 72, a fourth head 73, a first disk 60, a second disk 61, a read/write controller 40, and a vibration detector 30. As illustrated in FIG. 2, the storage device 10 of the first embodiment is connected to a host computer 90.

The host computer 90 transmits a write command and write data corresponding to the write command to the storage device 10.

The I/F 80 is an interface that relays data exchanged between the host computer 90 and the storage device 10.

The first disk 60 and the second disk 61 are two magnetic disks that are incorporated in the storage device 10. The first head 70 is a magnetic head that is arranged on a front surface of the first disk 60, and the second head 71 is a magnetic head that is arranged on a rear surface of the first disk 60. The third head 72 is a magnetic head that is arranged on a front surface of the second disk 61, and the fourth head 73 is a magnetic head that is arranged on a rear surface of the second disk 61.

The vibration detector 30 detects the vibration amount of each of the first head 70, the second head 71, the third head 72, and the fourth head 73 when a write command is executed. Specifically, the vibration detector 30 acquires the off-track amount of each of the first head 70, the second head 71, the third head 72, and the fourth head 73 when the write command is executed, from the read/write controller 40 to be described in detail below, and detects the vibration amount according to the acquired off-track amount. For example, the vibration detector 30 determines the vibration amount in the head by numerical values of 6 stages of “0 to 5”, according to the off-track amount. The “vibration amount: 0” indicates that the vibration is not generated in the head, when the command is executed.

The read/write controller 40 transmits the write data transmitted from the command controller 20 to be described in detail below and the scheduled process position to the process execution head. The read/write controller 40 acquires the off-track amount of when the write command is executed from the head, and notifies the vibration detector 30 of the off-track amount.

The read/write controller 40 transmits the vibration amount determined by the vibration detector 30 to the command controller 20 to be described in detail below. The read/write controller 40 transmits the retry count of each of the first head 70, the second head 71, the third head 72, and the fourth head 73 when the write command is executed to the command controller 20 to be described in detail below. The read/write controller 40 calculates an “average retry count for every 0×100 sectors”, determines the calculated average retry count as a “retry count”, and transmits the retry count to the command controller 20 to be described in detail below.

In this case, the read/write controller 40 transmits “1” as information to specify the head, with respect to the retry count and the vibration amount of the first head 70. Similarly, the read/write controller 40 transmits “2” with respect to the retry count and the vibration amount of the second head 71, “3” with respect to the retry count and the vibration amount of the third head 72, and “4” with respect to the retry count and the vibration amount of the fourth head 73.

The storage module 50 is a data buffer that stores data needed to execute various processes by the command controller 20 to be described in detail below, and comprises a command storage module 51 and a vibration correspondence information storage module 52.

The command storage module 51 stores a write command and write data from the host computer 90, which are received by the command controller 20 to be described in detail below through the I/F 80, as a command waiting matrix. For example, the command storage module 51 associates a command number, a command execution position, and write data with each other and stores an association result (see command waiting matrix of FIG. 1).

To perform a write command process of when the vibration is generated in the shortest time, the vibration correspondence information storage module 52 previously stores two pieces of information to be described in detail below. First, the vibration correspondence information storage module 52 stores vibration correspondence information where an “execution head of a process”, the “vibration amount in the execution head”, and the “retry count”, which are transmitted from the read/write controller 40 through the command controller 20 to be described in detail below, are associated with each other.

For example, when the execution head of the process is “1”, the vibration amount of when the process of the head “1” is performed is “3”, and the retry count is “1”, the vibration correspondence information storage module 52 stores vibration correspondence information of “head: 1, vibration amount: 3, and retry count: 1”, as illustrated in FIG. 3.

When the head used to execute the write command process is changed, the vibration correspondence information storage module 52 stores the increase/decrease amount of the vibration amount between the heads before and after the change as differential information.

Specifically, the vibration correspondence information storage module 52 stores the increase/decrease amount of the vibration amount of the head (current head) before the change and the vibration amount of the head (seek destination head) after the change, which are transmitted from the read/write controller 40 through the command controller 20 to be described in detail below. The increase/decrease amount of the vibration amount is calculated by the command controller 20 to be described in detail below.

For example, when the head before the change is “1”, the head after the change is “3”, and the increase/decrease amount of the vibration amount between the heads before and after the change is “+1”, the vibration correspondence information storage module 52 stores differential information of “current head: 1, seek destination head: 3, and increase/decrease amount: “+1”, as illustrated in FIG. 4.

The acquiring processes of the vibration correspondence information and the differential information will be described in detail below.

The command controller 20 uses a control program or control data that defines various process sequences stored in a ROM (not illustrated), to execute various processes. In this case, the command controller 20 comprises a data processor 21, a process completion prediction time calculator 22, a next execution command determining module 23, and a command execution controller 24 as illustrated in FIG. 2.

The data processor 21 transmits a write command received from the host computer 90 through the I/F 80 and write data corresponding to the write command to the command storage module 51 in the storage module 50. The data processor 21 reads the write data corresponding to the write command from the command storage module 51, and transmits the write data to the read/write controller 40. Further, the data processor 21 receives the vibration amount for every head and the retry count transmitted from the read/write controller 40, and transmits the vibration amount and the retry count to the vibration correspondence information storage module 52.

When write commands (unexecuted commands) as a command waiting matrix are newly stored in the command storage module 51 after the vibration correspondence information and the differential information are stored in the vibration correspondence information storage module 52, the data processor 21 performs the following process. That is, to perform a corresponding next execution command determining process when a vibration is generated, the data processor 21 reads a command number of a write command and a command execution position from the command storage module 51, and transmits the command number and the command execution position to the process completion prediction time calculator 22 to be described in detail below. To perform the corresponding next execution command determining process when the vibration is generated, the data processor 21 reads the vibration correspondence information or the differential information from the vibration correspondence information storage module 52 and transmits the vibration correspondence information or the differential information to the process completion prediction time calculator 22 to be described in detail below.

The data processor 21 reads the write data corresponding to the next execution command determined to correspond to the case where the vibration is generated, according to an instruction from the command execution controller 24 to be described in detail below, and transmits the write data to the read/write controller 40. The detailed contents of the process by the data processor 21 will be described in detail below, when the process sequence by the storage device 10 is described.

The process completion prediction time calculator 22 calculates an arrival time needed until the scheduled execution head for each unexecuted command arrives from the current position on the disk to the scheduled process position.

Specifically, as illustrated in FIG. 5, the process completion prediction time calculator 22 calculates an arrival time (Z) by adding a seek time (a) needed until the head is moved to the track where the scheduled process position exists and a rotation waiting time (b) needed until the scheduled process position on the disk rotates to the position of the scheduled execution head.

In addition, the process completion prediction time calculator 22 calculates a process completion prediction time of the unexecuted command, from the calculated arrival time and the retry count corresponding to the scheduled execution head and the current vibration amount in the scheduled execution head in the vibration correspondence information stored by the vibration correspondence information storage module 52. The vibration correspondence information that is stored by the vibration correspondence information storage module 52 is extracted by the data processor 21 and transmitted.

Specifically, as illustrated in FIG. 6, first, the process completion prediction time calculator 22 uses the vibration amount (X) in the immediately previous execution head and the increase/decrease amount (Y) of the vibration amount to derive the current vibration amount (X+Y) in the scheduled execution head. When the scheduled execution head and the immediately previous execution head are the same, the process completion prediction time calculator 22 determines a value of the increase/decrease amount (Y) of the vibration amount as “0”, and derives the current vibration amount in the scheduled execution head.

Meanwhile, when the scheduled execution head is changed from the immediately previous execution head, the process completion prediction time calculator 22 acquires the value of the increase/decrease amount (Y) of the vibration amount from the differential information stored by the vibration correspondence information storage module 52, and derives the current vibration amount (X+Y) in the scheduled execution head. The differential information that is stored by the vibration correspondence information storage module 52 is extracted by the data processor 21 and transmitted.

In addition, the process completion prediction time calculator 22 acquires the retry count (n) corresponding to the scheduled execution head and the current vibration amount (X+Y) in the scheduled execution head, from the vibration correspondence information stored by the vibration correspondence information storage module 52. The process completion prediction time calculator 22 calculates a process completion prediction time “retry count (n)×one-time rotation time (constant)+arrival time (Z)” of the unexecuted command, from the calculated arrival time (Z), the retry count (n), and the time (constant) needed until the disk rotates once.

For example, as illustrated in FIG. 7A, when the immediately previous execution head is “1” and the vibration amount in the head “1” is “1”, the process completion prediction time calculator 22 calculates the process completion prediction time of “command number: 1”, “command number: 2”, and “command number: 3” illustrated in FIG. 1 as follows.

First, as illustrated in FIG. 7B, the process completion prediction time calculator 22 derives the current vibration amount “(1+0)=1” of the scheduled execution head “1”, because the scheduled execution head of “command number: 1” is “1” and is the same as the immediately previous execution head “1”.

In addition, the process completion prediction time calculator 22 acquires the retry count “0” corresponding to the vibration amount “1” in the head “1” from the vibration correspondence information (see FIG. 3). The process completion prediction time calculator 22 calculates the process completion prediction time “0×11.1+11=11 ms” from the acquired retry count “0”, the time “11.1 ms” needed until the disk rotates once, and the arrival time “(9+2)=11 ms”.

As illustrated in FIG. 7C, since the scheduled execution head of “command number: 2” is “3” and is changed from the immediately previous execution head “1”, the process completion prediction time calculator 22 derives the current vibration amount “(1+1)=2” of the scheduled execution head “3” from the differential information (see FIG. 4).

In addition, the process completion prediction time calculator 22 acquires the retry count corresponding to the vibration amount “1” in the head “3” from the vibration correspondence information illustrated in FIG. 3. The process completion prediction time calculator 22 calculates the process completion prediction time “1×11.1+13=24.1 ms” from the acquired retry count “1”, the time “11.1 ms” needed until the disk rotates once, and the arrival time “(10+3)=13 ms”.

Similarly, as illustrated in FIG. 7C, since the scheduled execution head of “command number: 3” is “4” and changed from the immediately previous execution head “1”, the process completion prediction time calculator 22 derives the current vibration amount “(1+2)=3” of the scheduled execution head “4” from the differential information (see FIG. 4).

In addition, the process completion prediction time calculator 22 acquires the retry count corresponding to the vibration amount “3” in the head “4” from the vibration correspondence information illustrated in FIG. 3. The process completion prediction time calculator 22 calculates the process completion prediction time “2×11.1+7=29.2 ms” from the acquired retry count “2”, the time “11.1 ms” needed until the disk rotates once, and the arrival time “(5+2)=7 ms”.

The next execution command determining module 23 acquires a process completion prediction time of each unexecuted command calculated from the process completion prediction time calculator 22, and determines a write command, which needs the shortest process completion prediction time among the acquired process completion prediction times, as a next execution command.

For example, the next execution command determining module 23 determines the write command of “command number: 1”, which needs the shortest process completion prediction time among the calculated process completion prediction times of “command number: 1”, “command number: 2”, and “command number: 3”, as the next execution command.

The command execution controller 24 notifies the data processor 21 of the next execution command determined by the next execution command determining module 23. The data processor 21 reads a command execution position and data of the notified next execution command from the command storage module 51, and transmits the command execution position and the data to the read/write controller 40.

After determining the corresponding next execution command when the vibration is generated, the command controller 20 calculates the process completion prediction time again with respect to the unexecuted commands remaining in the command waiting matrix, and determines the unexecuted command where the process time is the shortest as the next execution command.

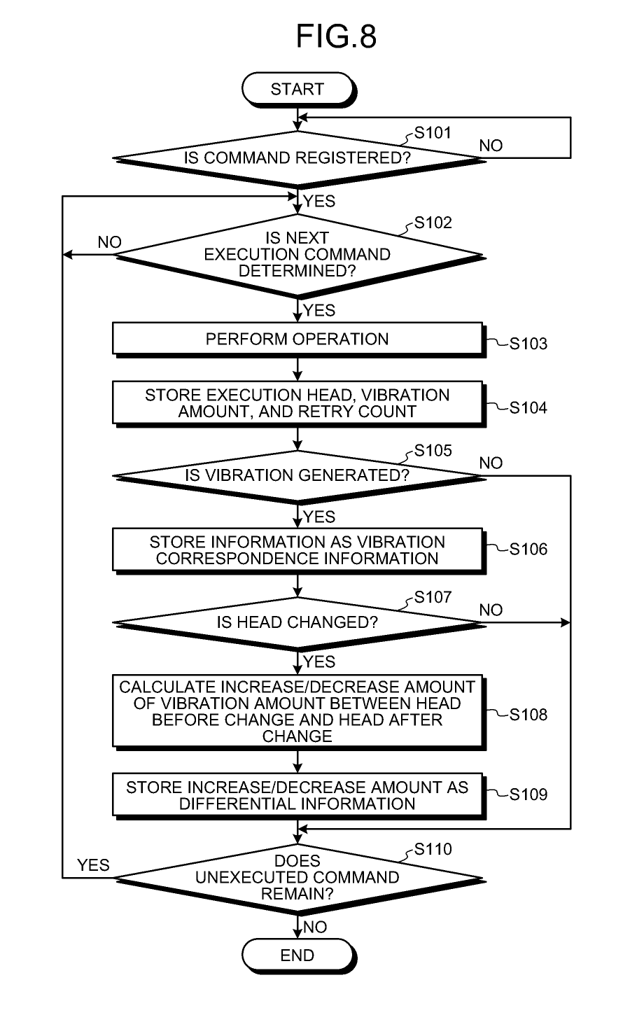

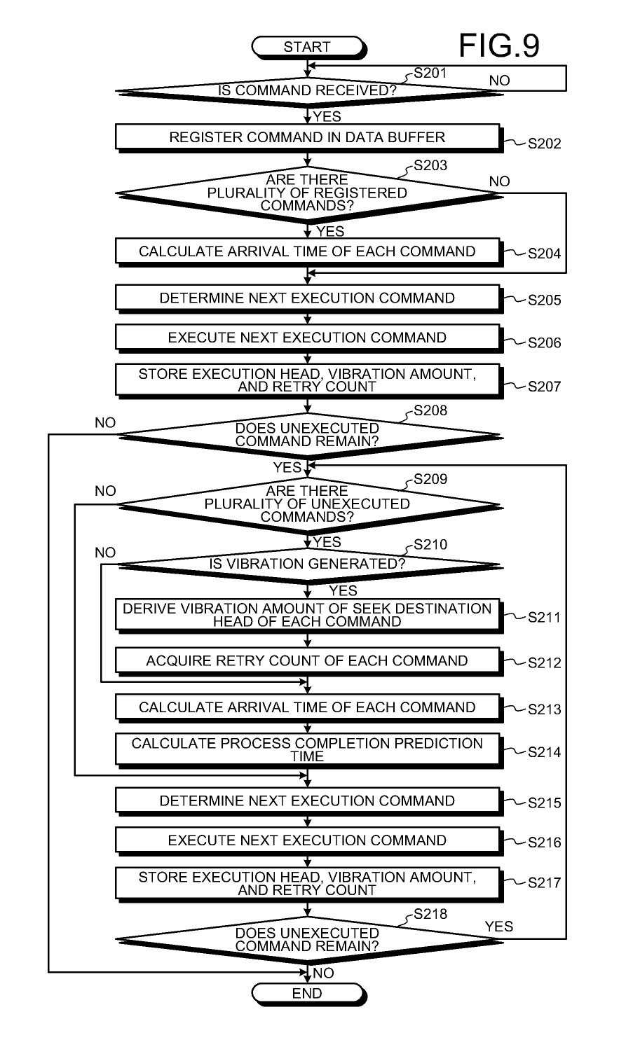

Next, process performed by the storage device of the first embodiment will be described with reference to FIGS. 8 and 9. FIG. 8 illustrates an acquiring process of vibration correspondence information and differential information performed by the storage device of the first embodiment. FIG. 9 illustrates a next execution command determining process performed by the storage device of the first embodiment.

Described below is the acquiring process of vibration correspondence information and differential information performed by the storage device of the first embodiment. As illustrated in FIG. 8, first, in the storage device 10 of the first embodiment, when the write command is registered in the command storage module 51 (Yes at S101), a next execution command is determined by the command controller 20. For example, the command controller 20 uses only the arrival time of each write command calculated by the process completion prediction time calculator 22 to determine the next execution command. When the next execution command is determined by the command controller 20 (Yes at S102), under the control of the data processor 21 through the read/write controller 40, the first head 70, the second head 71, the third head 72, and the fourth head 73 perform writing with respect to the first disk 60 or the second disk 61 (S103).

In this case, the read/write controller 40 temporarily stores information of the execution head of the process, the vibration amount in the execution head, and the retry count in a memory (not illustrated) (S104).

In addition, when the vibration amount stored by the memory of the read/write controller 40 is not “0”, that is, the vibration is generated (Yes at S105), the data processor 21 stores the information on the execution head of the process, the vibration amount in the execution head, and the retry count as the vibration correspondence information in the vibration correspondence information storage module 52 (S106).

Next, when the execution head of the process is changed from the immediately previous execution head (Yes at S107), the data processor 21 calculates the increase/decrease amount of the vibration amount between the head before the change and the head after the change (S108), and stores the increase/decrease amount as the differential information in the vibration correspondence information storage module 52 (S109).

In this case, when the unexecuted command remains in the command storage module 51 (Yes at S110), the process returns to S102, and the same process is repeated.

Meanwhile, when the unexecuted command does not remain in the command storage module 51 (No at S110), the storage device 10 of the first embodiment completes the process. That is, when the vibration is generated in the executed command, the storage device 10 of the first embodiment acquires the vibration correspondence information. When the head is changed, the storage device 10 acquires the differential information.

Described below is the next execution command determining process performed by the storage device of the first embodiment. As illustrated in FIG. 9, first, in the storage device 10 of the first embodiment, after the vibration correspondence information and the differential information are stored in the vibration correspondence information storage module 52, when a write command is received from the host computer 90 (Yes at S201), the data processor 21 registers the received write command in the command waiting matrix of the command storage module 51 (S202).

When the number of the registered write commands is one (No at S203), the next execution command determining module 23 determines the registered write command as the next execution command (S205).

Meanwhile, when there are a plurality of registered write commands (Yes at S203), the data processor 21 transmits command execution positions of the write commands to the process completion prediction time calculator 22. In addition, the process completion prediction time calculator 22 calculates an arrival time of each write command (S204), and the next execution command determining module 23 determines the next execution command based only on the arrival time of each write command that is calculated by the process completion prediction time calculator 22 (S205).

By the control through the command execution controller 24, the data processor 21, and the read/write controller 40, the first head 70, the second head 71, the third head 72, and the fourth head 73 perform writing of the write data corresponding to the next execution command (S206).

After the writing is completed, the read/write controller 40 stores the execution head of the process, the vibration amount in the execution head, and the retry count in a memory (not illustrated) (S207).

When the unexecuted command does not remain in the command storage module 51 (No at S208), the process ends.

Meanwhile, when the unexecuted command remains in the command storage module 51 (Yes at S208), the data processor 21 determines whether there are a plurality of unexecuted commands (S209).

When the data processor 21 determines that the number of unexecuted commands is one (No at S209), the next execution command determining module 23 determines the remaining one write command as the next execution command (S215). By the control through the command execution controller 24, the data processor 21, and the read/write controller 40, the first head 70, the second head 71, the third head 72, and the fourth head 73 perform writing of the write data corresponding to the next execution command (S216).

After the writing is completed, the read/write controller 40 stores the execution head of the process, the vibration amount in the execution head, and the retry count in a memory (not illustrated) (S217). In addition, the data processor 21 determines whether the unexecuted command remains (S218). In the case of “No at S209”, the determination of S218 becomes “No”, and the process ends.

Meanwhile, when there are a plurality of unexecuted commands (Yes at S209), the data processor 21 transmits the command execution positions of the unexecuted commands to the process completion prediction time calculator 22.

The data processor 21 determines whether the vibration is generated in the immediately previous execution command based on the vibration amount stored in the memory of the read/write controller 40 (S210).

When the data processor 21 determines that the vibration is not generated in the immediately previous execution command (No at S210), the process completion prediction time calculator 22 calculates an arrival time of each of the unexecuted commands (S213). In addition, the process completion prediction time calculator 22 determines the calculated arrival time as the process completion prediction time (S214), and the next execution command determining module 23 determines the unexecuted command of which the process completion prediction time is the shortest as the next execution command (S215). The storage device 10 of the first embodiment performs next execution command executing process at S216, various information storing process at S217, and determining process at S218.

Meanwhile, when it is determined that the vibration is generated in the immediately previous execution command (Yes at S210), the data processor 21 acquires the vibration amount in the immediately previous execution head stored in the memory of the read/write controller 40, and transmits the vibration amount to the process completion prediction time calculator 22.

In addition, the process completion prediction time calculator 22 derives the vibration amount in the scheduled execution head of each unexecuted command (S211). That is, when the immediately previous execution head and the scheduled execution head are the same, the process completion prediction time calculator 22 derives the vibration amount in the immediately previous execution head as the vibration amount in the scheduled execution head. When the immediately previous execution head and the scheduled execution head are different from each other, the process completion prediction time calculator 22 acquires the increase/decrease amount corresponding to the immediately previous execution head and the scheduled execution head from the differential information through the data processor 21, adds the increase/decrease amount to the vibration amount in the immediately previous execution head, and derives the vibration amount in the scheduled execution head.

The process completion prediction time calculator 22 acquires the retry count in the scheduled execution head of each unexecuted command based on the derived vibration amount and the vibration correspondence information transmitted by the data processor 21 (S212). Next, the process completion prediction time calculator 22 calculates an arrival time of each unexecuted command (S213), and calculates the process completion prediction time from the calculated arrival time and the retry count acquired at S212 (S214).

The next execution command determining module 23 determines the next execution command based on the process completion prediction time of each write command that is calculated by the process completion prediction time calculator 22 (S215).

The storage device 10 of the first embodiment performs next execution command executing process at S216, various information storing process at S217, and determining process at S218.

During the determining process of S218, when it is determined that the unexecuted command remains (Yes at S218), the process returns to S209, and the data processor 21 determines the number of unexecuted commands.

Meanwhile, when the data processor 21 determines that the unexecuted command does not remain (No at S218), the process ends.

Even when the determining and executing processes of the next execution command are performed, the storage device 10 of the first embodiment acquires the vibration amount, the retry count, and the increase/decrease amount of the vibration amount, and updates the vibration correspondence information and the differential information.

As described above, according to the first embodiment, each time a write command process is performed by the head with respect to the disk, the vibration correspondence information storage module 52 stores an execution head of the write command process, the vibration amount of the execution head, and a retry count until the write command process is completed in association with one another as the vibration correspondence information. In addition, the process completion prediction time calculator 22 calculates, for each unexecuted command registered in the command waiting matrix, an arrival time taken for the scheduled execution head to arrive at the scheduled process position from the current position on the disk.

The process completion prediction time calculator 22 calculates the predicted process completion prediction time indicating the time expected to be taken to complete the process corresponding to the unexecuted command from the retry count corresponding to the scheduled execution head and the current vibration amount of the scheduled execution head in the vibration correspondence information and the arrival time. The next execution command determining module 23 determines the write command with the shortest process completion prediction time among the calculated process completion prediction times as the next execution command. Accordingly, the process completion prediction time can be calculated taking into account the retry count of each command when the vibration is generated. Thus, a command of which the process time when the vibration is generated is the shortest can be accurately determined.

According to the first embodiment, when the head used for the write command process is changed, the vibration correspondence information storage module 52 further stores the increase/decrease in the vibration amount of the heads before and after the change as the differential information. When the immediately previous execution head is changed to a scheduled execution head other than the immediately previous execution head, the process completion prediction time calculator 22 derives the current vibration amount of the scheduled execution head from the increase/decrease in the vibration amount of the heads before and after the change acquired from the differential information and the vibration amount of the immediately previous execution head.

The process completion prediction time calculator 22 acquires the retry count associated with the scheduled execution head and the derived vibration amount from the vibration correspondence information, and calculates the process completion prediction time from the acquired retry count and arrival time. Accordingly, even when the head is changed, the process completion prediction time can be calculated taking into account the retry count of each command when the vibration is generated, and the command of which the process time when the vibration is generated is the shortest can be accurately determined.

In the first embodiment, the case is described where the vibration correspondence information is stored for each head. According to a second embodiment of the invention, the vibration correspondence information is stored for each head and each processed area where each head performs process.

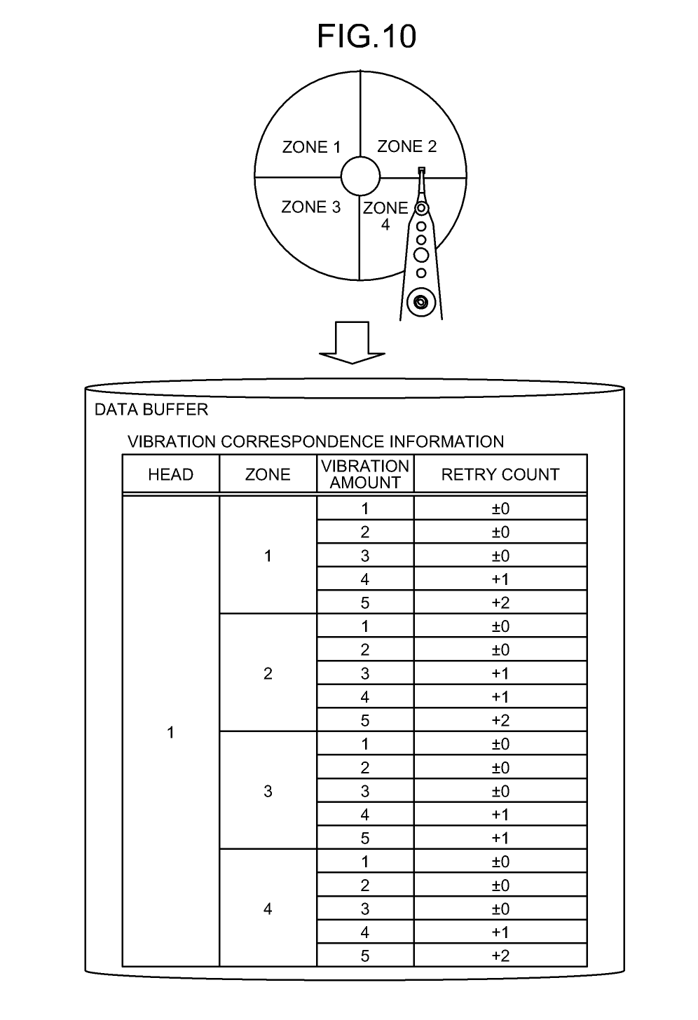

First, the outline the storage device according to the second embodiment will be described with reference to FIG. 10. FIG. 10 illustrates the outline of the storage device of the second embodiment.

Each time a process of a write command is performed by a head with respect to the disk, the storage device of the second embodiment acquires the retry count and the vibration amount of the head for each processed area on the disk, and further stores the vibration amount and the retry count in association with the vibration correspondence information. For example, as illustrated in FIG. 10, the entire area of the disk is divided into four processed areas (zones 1, 2, 3, and 4), and the storage device of the second embodiment stores the retry count and the vibration amount of a head that performs process in association with each other for each zone as the vibration correspondence information in the data buffer.

The storage device of the second embodiment acquires the retry count corresponding to the scheduled execution head, the scheduled execution area of the scheduled execution head in the disk, and the current vibration amount in the scheduled execution area of the scheduled execution head, from the vibration correspondence information, and calculates the process completion prediction time.

For example, when the immediately previous execution head is “1”, the vibration amount in the head “1” is “3”, and the command execution position of the unexecuted command is “head: 1, zone: 2”, the controller of the storage device in the second embodiment calculates the process completion prediction time as follows. First, the controller of the storage device in the second embodiment determines the current vibration amount of the command execution position as “3”, because the scheduled execution head is “1” and is the same as the immediately previous execution head “1”.

The controller of the storage device of the second embodiment acquires the retry count “1” corresponding to the vibration amount “3” in the command execution position “head: 1, zone: 2” from the vibration correspondence information illustrated in FIG. 10, and calculates the process completion prediction time from the acquired retry count “1”, the time needed until the disk rotates once, and the arrival time. When the arrival time needed until the scheduled execution head of the unexecuted command arrives to the scheduled process position is “12 ms” and the time needed until the disk rotates once is “11.1 ms”, the controller of the storage device of the second embodiment calculates the process completion prediction time as “1×11.1+12=23.1 ms”.

When the scheduled execution head and the immediately previous execution head are different from each other, similar to the first embodiment, the controller of the storage device of the second embodiment acquires the increase/decrease amount from the differential information, and derives the vibration amount of the scheduled execution head. In addition, the controller of the storage device of the second embodiment acquires the retry count corresponding to the derived vibration amount and the scheduled execution area of the scheduled execution head from the vibration correspondence information, and calculates the process completion prediction time.

The controller of the storage device of the second embodiment calculates the process completion prediction time with respect to all of the unexecuted commands, and determines the write command, which needs the shortest process completion prediction time among the calculated process completion prediction times, as the next execution command.

Even when the vibration amount of the head varies depending on the process performed zone, the storage device of the second embodiment can calculate the process completion prediction time to correspond to the variation, and can accurately determine the command where the process time of when the vibration is generated is the shortest.

In the second embodiment, the case is described where the zone information is further associated in the vibration correspondence information, but it is not so limited. Even in the differential information, zone information of the current head and zone information of the seek destination head may be further associated.

Next, the configuration of the storage device of the second embodiment will be described with reference to FIG. 2. FIG. 2 is a block diagram of the storage device of the second embodiment.

As illustrated in FIG. 2, the storage device 10 of the second embodiment comprises the same functional blocks as the storage device of the first embodiment. However, the second embodiment is different from the first embodiment in contents stored by the vibration correspondence information storage module 52 and process performed by the process completion prediction time calculator 22. Hereinafter, the difference will be mainly described.

The vibration correspondence information storage module 52 of the second embodiment further associates a “processed area of the execution head of the process in the disk”, the “vibration amount of the processed area of the execution head in the disk”, and the “retry count”, which are transmitted through the command controller 20, with the vibration correspondence information, and stores an association result.

For example, when the processed area is “head: 1, zone: 1” and the vibration amount at the time of executing the process is “4”, and the retry count is “1”, the vibration correspondence information storage module 52 of the second embodiment stores vibration correspondence information of “head: 1, zone: 1, vibration amount: 4, and retry count: 1” (see FIG. 10).

As in the first embodiment, when the process execution head and the immediately previous execution head are different from each other, the vibration correspondence information storage module 52 of the second embodiment further associates the increase/decrease amount of the vibration amount of the head before the change and the vibration amount of the head after the change with the differential information and stores an association result.

The process completion prediction time calculator 22 of the second embodiment acquires the retry count corresponding to the “scheduled execution area of the scheduled execution head in the disk” and the “current vibration amount in the scheduled execution area of the scheduled execution head” from the vibration correspondence information, and calculates the process completion prediction time, similar to the first embodiment.

As in the first embodiment, when the immediately previous execution head and the scheduled execution head are the same, the process completion prediction time calculator 22 of the second embodiment determines the vibration amount of the immediately previous execution head as the vibration amount of the scheduled execution head, and acquires the retry count from the vibration correspondence information.

When the scheduled execution head and the immediately previous execution head are different from each other, similar to the first embodiment, the process completion prediction time calculator 22 of the storage device of the second embodiment acquires the increase/decrease amount from the differential information and derives the vibration amount in the process area of the scheduled execution head. In addition, the process completion prediction time calculator 22 of the storage device of the second embodiment acquires the retry count corresponding to the derived vibration amount and the scheduled execution area of the scheduled execution head from the vibration correspondence information, and calculates the process completion prediction time.

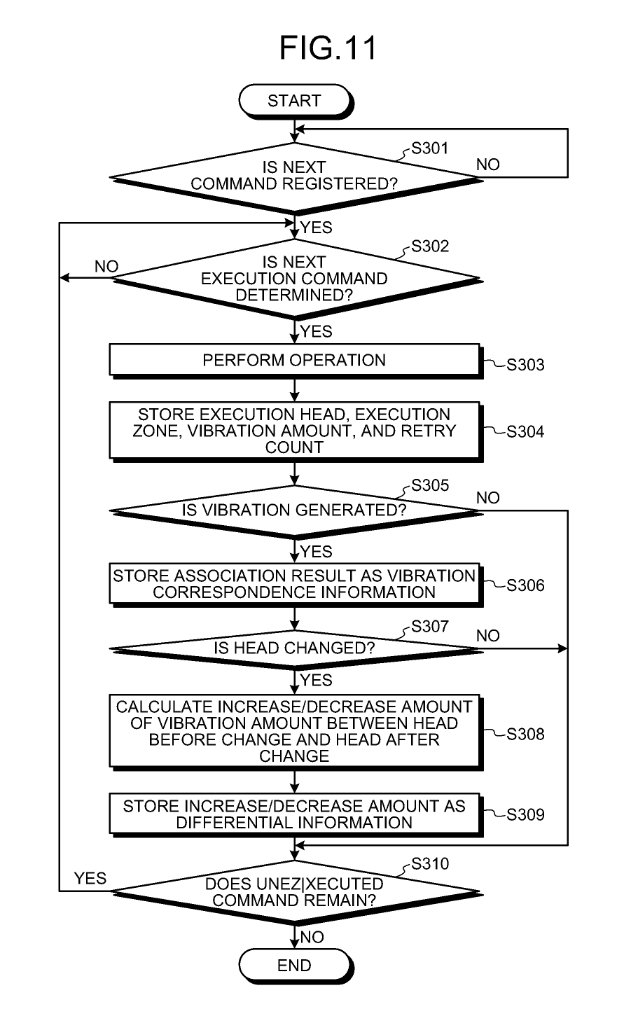

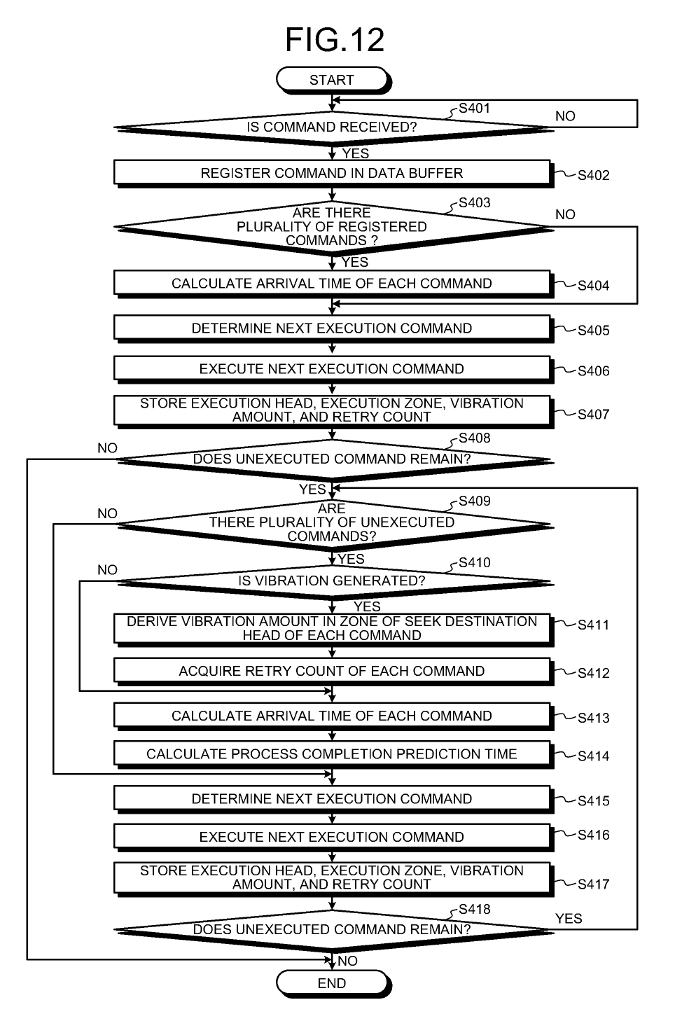

Next, process performed by the storage device of the second embodiment will be described with reference to FIGS. 11 and 12. FIG. 11 illustrates an acquiring process of vibration correspondence information and differential information performed by the storage device of the second embodiment. FIG. 12 illustrates a next execution command determining process performed by the storage device of the second embodiment.

Described below is the acquiring process of vibration correspondence information and differential information performed by the storage device of the second embodiment. As illustrated in FIG. 11, the acquiring process of the vibration correspondence information and the differential information by the storage device of the second embodiment is basically similar to the acquiring process of the vibration correspondence information and the differential information by the storage device of the first embodiment previously described in connection with FIG. 8.

In FIG. 11, the process of S304 corresponding to S104 of FIG. 8 and the process of S306 corresponding to S106 of FIG. 8 are different from those in the first embodiment. Hereinafter, only the difference will be described.

After the process of S303 is completed, the read/write controller 40 of the second embodiment temporarily stores the processed area of the process execution head, the vibration amount in the processed area, and the retry count in a memory (not illustrated) (S304).

In addition, when the vibration is generated (Yes at S305), the data processor 21 of the second embodiment associates the processed area of the process execution head, the vibration amount in the processed area, and the retry count with each other and stores an association result as the vibration correspondence information in the vibration correspondence information storage module 52 (S306).

Described below is the next execution command determining process performed by the storage device of the second embodiment. As illustrated in FIG. 12, the next execution command determining process performed by the storage device of the second embodiment is basically similar to the next execution command determining process performed by the storage device of the first embodiment previously described in connection with FIG. 9.

In FIG. 12, the process of S407 corresponding to S207 of FIG. 9, the process of S412 corresponding to S212 of FIG. 9, and the process of S417 corresponding to S217 of FIG. 9 are different from those in the first embodiment. Hereinafter, only the difference will be described.

After the writing at S406 is completed, the read/write controller 40 of the second embodiment temporarily stores the processed area of the process execution head, the vibration amount in the processed area, and the retry count in a memory (not illustrated) (S407).

When the vibration is generated (Yes at S410), the process completion prediction time calculator 22 of the second embodiment derives the vibration amount in the processed area of each unexecuted command. That is, when the immediately previous execution head and the scheduled execution head are the same, the process completion prediction time calculator 22 derives the vibration amount in the immediately previous execution head as the vibration amount in the processed area of the scheduled execution head. When the immediately previous execution head and the scheduled execution head are different from each other, the process completion prediction time calculator 22 acquires the increase/decrease amount corresponding to the processed area of the immediately previous execution head and the processed area of the scheduled execution head from the differential information through the data processor 21, adds the increase/decrease amount to the vibration amount in the processed area of the immediately previous execution head, and derives the vibration amount in the scheduled execution head (S411).

The process completion prediction time calculator 22 of the second embodiment acquires the retry count in the processed area of the scheduled execution head of each unexecuted command based on the derived vibration amount and the vibration correspondence information transmitted by the data processor 21 (S412).

After the completion of the writing corresponding to the next execution command at S416, the read/write controller 40 of the second embodiment temporarily stores the processed area of the process execution head, the vibration amount in the processed area, and the retry count in a memory (not illustrated) (S417).

As described above, according to the second embodiment, the vibration correspondence information storage module 52 acquires the retry count and the vibration amount for each processed area of the head in the disk, and further associates the retry count and the vibration amount with the vibration correspondence information and stores an association result, each time the write command process is performed by the head with respect to the disk. In addition, the process completion prediction time calculator 22 calculates the process completion prediction time, from the retry count corresponding to the scheduled execution head, the scheduled execution area of the scheduled execution head in the disk, and the current vibration amount in the scheduled execution area and the arrival time. Accordingly, even when the vibration amount of the head varies depending on the process performed zone, the storage device of the second embodiment can calculate the process completion prediction time to correspond to the variation, and can accurately determine the command of which the process time when the vibration is generated is the shortest.

In the first and second embodiments, the case is described where a command of which the process completion prediction time is the shortest is determined as the next execution command. According to a third embodiment of the invention, the case is described where a command of which the process completion prediction time is expected to be the longest is determined as a next execution command.

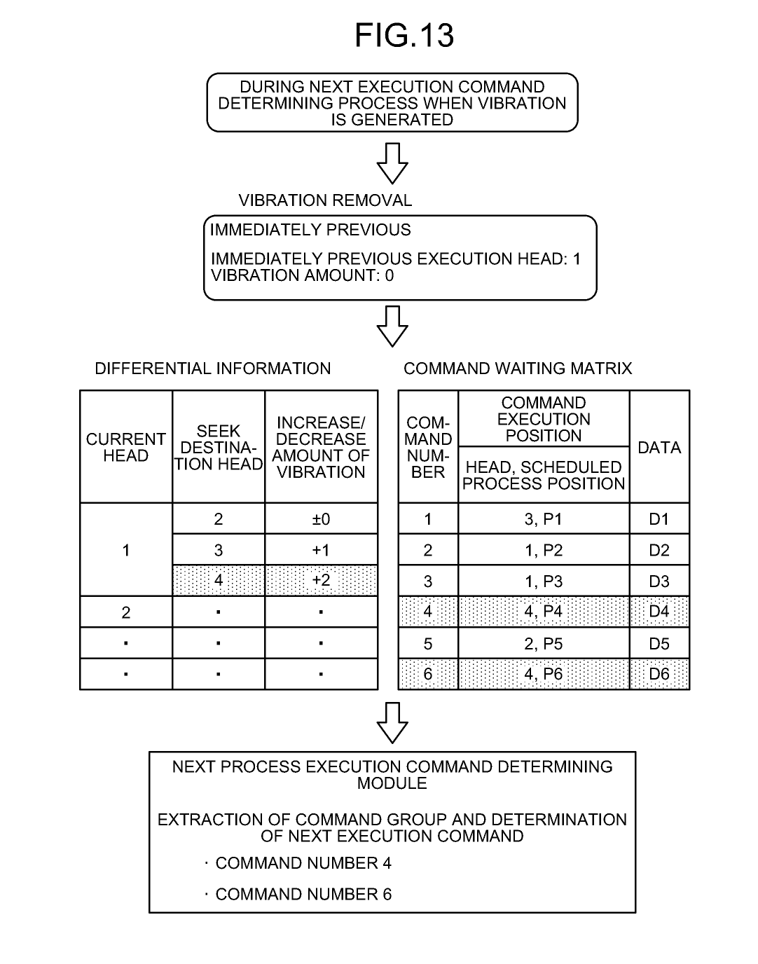

First, the outline the storage device of the third embodiment will be described with reference to FIG. 13. FIG. 13 illustrates the outline of the storage device in the third embodiment.

When the vibration is removed during the next execution command determining process, the storage device of the third embodiment extracts a command group using the scheduled execution head predicted as having the largest vibration amount from the unexecuted commands based on the immediately previous execution head and the differential information. The storage device in the third embodiment determines the extracted command group as the next execution command group.

For example, as illustrated in FIG. 13, when the vibration is removed during the execution of the next execution command determining process, the storage device in the third embodiment determines a seek destination head “4” that is predicted as having the increase/decrease amount of the vibration amount of the seek destination head corresponding to the immediately previous execution head “1” being the largest, for example, “+2” based on the differential information. In addition, as illustrated in FIG. 13, the storage device in the third embodiment extracts a command group “command numbers: 4 and 6” using the predicted seek destination head from the command waiting matrix, and determines the extracted command group as the next execution command group.

As a result, the storage device in the third embodiment can collectively process commands remaining as the unexecuted commands having the low priority order in the command waiting matrix, when the vibration is removed, and decrease the process time according to the increase/decrease in the vibration.

Next, the configuration of the storage device of the third embodiment will be described with reference to FIG. 2. FIG. 2 is a block diagram of the storage device of the third embodiment.

As illustrated in FIG. 2, the storage device 10 of the third embodiment comprises the same functional blocks as the storage device 10 of the first embodiment. However, the third embodiment is different from the first embodiment in contents of process of the next execution command determining module 23. Hereinafter, the difference will be mainly described.

When the vibration is removed during the execution of the next execution command determining process, the next execution command determining module 23 in the third embodiment extracts a command group using the scheduled execution head predicted as having the largest vibration amount from the unexecuted commands based on the immediately previous execution head and the differential information. The next execution command determining module 23 in the third embodiment determines the extracted command group as the next execution command group (see FIG. 13).

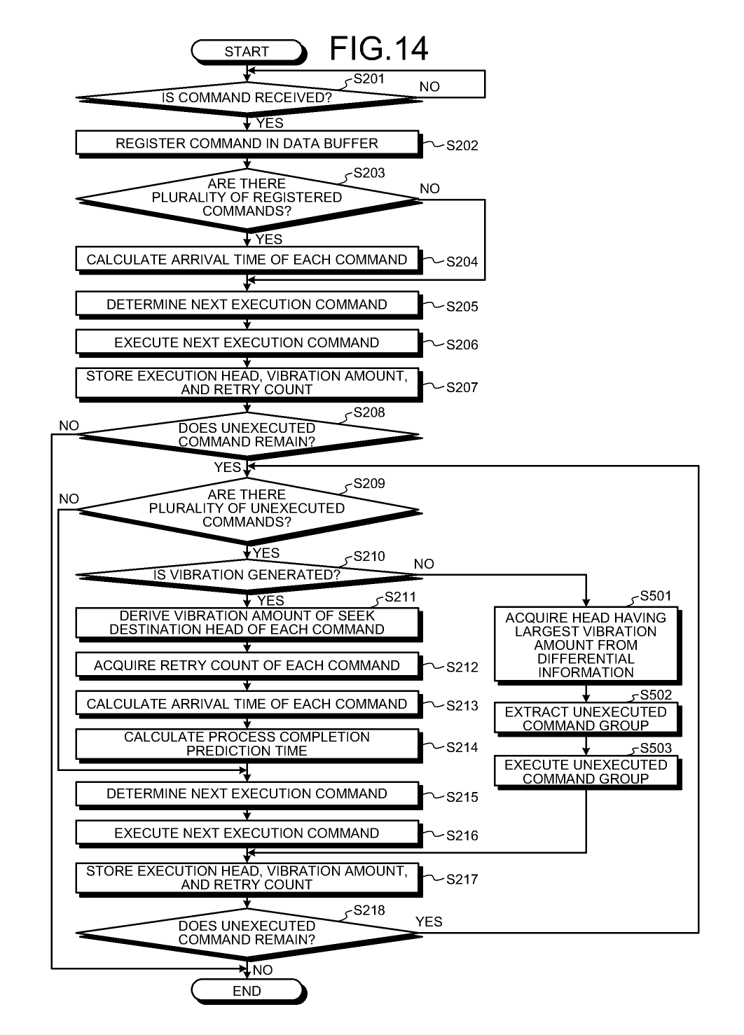

Next, a next execution command determining process performed by the storage device of the third embodiment will be described with reference to FIG. 14. FIG. 14 illustrates the next execution command determining process performed by the storage device of the third embodiment. The storage device of the third embodiment performs basically the same acquiring process of the vibration correspondence information and the differential information as previously described for the storage device of the first embodiment in connection with FIG. 8, and the description thereof is omitted.

As illustrated in FIG. 14, as with the storage device 10 of the first embodiment, the storage device 10 of the third embodiment performs the process from S201 to S218 in FIG. 9.

As illustrated in FIG. 14, when the data processor 21 determines that the vibration is not generated (No at S210), the storage device 10 of the third embodiment performs the process from S501 to S503, which will be described in detail below.

When the data processor 21 determines that the vibration in the immediately previous execution command is not generated (No at S210), the next execution command determining module 23 in the third embodiment acquires the differential information using the immediately previous execution head as the current head from the storage module 50 through the data processor 21, and acquires the scheduled execution head predicted as having the largest vibration amount (S501).

The next execution command determining module 23 in the third embodiment extracts a unexecuted command group using the scheduled execution head acquired at S501 from the unexecuted commands, which are acquired through the data processor 21 and registered in the storage module 50 (S502).

In addition, the next execution command determining module 23 in the third embodiment determines the extracted unexecuted command group as the next execution command group, and notifies the data processor 21 of the determined command group. As a result, each head performs the process of the next execution command group (S503).

In the third embodiment, the case is described where the next execution command group is determined each time it is determined that the vibration is not generated, but it is not so limited. At S210, only when it is determined that the vibration is not generated by continuously executing the above process by the predetermined number of times (for example, 10 times) or more, the process from S501 to S503 may be performed.

As described above, according to the third embodiment, when the vibration is removed during the execution of the next execution command determining process, the next execution command determining module 23 extracts the command group using the scheduled execution head predicted as having the largest vibration amount from the unexecuted commands based on the head used to execute the immediately previous process and the differential information stored by the vibration correspondence information storage module 52. In addition, the next execution command determining module 23 determines the extracted command group as a command group to execute a subsequent process. Accordingly, the storage device in the third embodiment can collectively process commands remaining as the unexecuted commands having the low priority order in the command waiting matrix, when the vibration is removed, and decrease the process time according to the increase/decrease in the vibration.

While specific embodiments have been described, other embodiments or modifications are also possible. In the following, such modifications will be described.

In the first to third embodiments, the case is described where write commands received from the host computer 90 are registered in the command waiting matrix. However, it is not so limited, and read commands received from the host computer 90 may be registered in the command waiting matrix.

For example, the storage device 10 stores the vibration amount of the head to perform reading and the retry count as vibration correspondence information, and stores the increase/decrease amount of the vibration amount before and after a change as differential information, when the head to perform the reading is changed. When a plurality of read commands are newly registered in the command waiting matrix, the storage device 10 calculates a process completion prediction time of each unexecuted command from the retry count, which is derived from the vibration correspondence information or the differential information.

As a result, the process completion prediction time can be calculated in consideration of the retry count of each read command of when the vibration is generated, comprising the case where the head is changed, and the read command where the process time of when the vibration is generated is the shortest can be accurately determined.

When the vibration is removed during the execution of the next execution command determining process, the storage device 10 extracts a read command group using a scheduled execution head predicted as having the largest vibration amount from unexecuted commands based on the immediately previous execution head and the differential information.

As a result, read commands remaining as the unexecuted commands having the low priority order in the command waiting matrix can be collectively processed when the vibration is removed, and the process time can be reduced according to increase/decrease in the vibration.

In the first to third embodiments, the case is described where one head is arranged on each of the front and rear surfaces of one disk. However, the embodiments may be applied to the case where a plurality of heads are arranged on the same surface of a disk.

In the first to third embodiments, the case is described where the storage device 10 is provided with a built-in magnetic disk. However, the storage device 10 may be provided with a built-in optical disk.

The process procedure, specific names, and information including various data and parameters described above in the embodiments can be arbitrarily changed unless otherwise specified. For example, the division of the processed area in the vibration correspondence information stored in the vibration correspondence information storage module 52 of the second embodiment may be arbitrarily set.

The constituent elements described above are functionally conceptual, and need not be physically configured as illustrated. In other words, the specific mode of dispersion and integration of the constituent elements (for example, the constituent elements illustrated in FIG. 2) is not limited to the ones illustrated in the drawings. For example, the vibration correspondence information storage module 52 is not necessarily located in the storage module 50, and may be located in the command controller 20.

As set forth hereinabove, according to an embodiment of the invention, a command of which a process time when a vibration is generated is the shortest can be accurately determined.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A storage device comprising:
a vibration correspondence information storage module configured to store, each time process is performed with respect to a storage medium, a head performing the process, a vibration amount of the head upon performing the process, and a process retry count indicating number of retries performed before the process is completed in association with one another as vibration correspondence information, the process including reading and writing with respect to the storage medium;
a process completion prediction time calculator configured to calculate, upon determining a next execution command to be executed next from among a plurality of unexecuted commands yet to be executed, for each of the unexecuted commands, process completion prediction time indicating time expected to be taken to complete process corresponding to the unexecuted command based on arrival time taken for a scheduled execution head that is to perform the process in response to the unexecuted command to arrive at a scheduled process position where the process is to be performed from a current position on the storage medium, and a process retry count associated with the scheduled execution head and a current vibration amount of the scheduled execution head in the vibration correspondence information stored in the vibration correspondence information storage module, the unexecuted commands including read commands and write commands with respect to the storage medium; and
a next execution command determining module configured to determine an unexecuted command with shortest process completion prediction time as the next execution command based on the process completion prediction time calculated for each of the unexecuted commands by the process completion prediction time calculator.

2. The storage device of claim 1, wherein
when the head performing the process is changed, the vibration correspondence information storage module further stores increase or decrease in vibration amount of heads before and after change as differential information, and
when a head that performs immediately previous process is changed to the scheduled execution head other than the head, the process completion prediction time calculator derives the current vibration amount of the scheduled execution head from a vibration amount of the head that performs the immediately previous process and increase or decrease in vibration amount acquired from the differential information stored in the vibration correspondence information storage module, and calculates the process completion prediction time from the process retry count associated with the current vibration amount of the scheduled execution head and the arrival time.

3. The storage device of claim 1, wherein
the vibration correspondence information storage module is configured to further store a processed area in the storage medium where the head performs the process in association with the vibration correspondence information, and
the process completion prediction time calculator is configured to calculate the process completion prediction time from the process retry count associated with the scheduled execution head, a processed area in the storage medium corresponding to the scheduled execution head, and a current vibration amount in the processed area in the vibration correspondence information, and the arrival time.

4. The storage device of claim 2, wherein, when the current vibration amount is equal to or less than a predetermined threshold value, the next execution command determining module extracts a command group using a scheduled execution head predicted as having largest vibration amount from the unexecuted commands based on the head that performs the immediately previous process and the differential information stored in the vibration correspondence information storage module, and determines to execute the command group next.

5. A control device configured to control a storage device that performs reading and writing by a head with respect to a storage medium, the control device comprising:
a vibration correspondence information storage module configured to store, each time process is performed with respect to the storage medium, a head performing the process, a vibration amount of the head upon performing the process, and a process retry count indicating number of retries performed before the process is completed in association with one another as vibration correspondence information, the process including reading and writing with respect to the storage medium;
a process completion prediction time calculator configured to calculate, upon determining a next execution command to be executed next from among a plurality of unexecuted commands yet to be executed, for each of the unexecuted commands, process completion prediction time indicating time expected to be taken to complete process corresponding to the unexecuted command based on arrival time taken for a scheduled execution head that is to perform the process in response to the unexecuted command to arrive at a scheduled process position where the process is to be performed from a current position on the storage medium, and a process retry count associated with the scheduled execution head and a current vibration amount of the scheduled execution head in the vibration correspondence information stored in the vibration correspondence information storage module, the unexecuted commands including read commands and write commands with respect to the storage medium; and
a next execution command determining module configured to determine an unexecuted command with shortest process completion prediction time as the next execution command based on the process completion prediction time calculated for each of the unexecuted commands by the process completion prediction time calculator.

6. The control device of claim 5, wherein
when the head performing the process is changed, the vibration correspondence information storage module further stores increase or decrease in vibration amount of heads before and after change as differential information, and
when a head that performs immediately previous process is changed to the scheduled execution head other than the head, the process completion prediction time calculator derives the current vibration amount of the scheduled execution head from a vibration amount of the head that performs the immediately previous process and increase or decrease in vibration amount acquired from the differential information stored in the vibration correspondence information storage module, and calculates the process completion prediction time from the process retry count associated with the current vibration amount of the scheduled execution head and the arrival time.

7. The control device of claim 5, wherein
the vibration correspondence information storage module is configured to further store a processed area in the storage medium where the head performs the process in association with the vibration correspondence information, and
the process completion prediction time calculator is configured to calculate the process completion prediction time from the process retry count associated with the scheduled execution head, a processed area in the storage medium corresponding to the scheduled execution head, and a current vibration amount in the processed area in the vibration correspondence information, and the arrival time.

8. The control device of claim 6, wherein, when the current vibration amount is equal to or less than a predetermined threshold value, the next execution command determining module extracts a command group using a scheduled execution head predicted as having largest vibration amount from the unexecuted commands based on the head that performs the immediately previous process and the differential information stored in the vibration correspondence information storage module, and determines to execute the command group next.
